(19) United States
(12) Patent Application Publication
(10) Pub. No.: US 2005/0236909 A1
(43) Pub. Date: Oct. 27, 2005

(54) Gravitational wave imaging

(76) Inventor: Robert M.L. Baker JR., Playa del Rey, CA (US)

Correspondence Address: CHRISTIE, PARKER & HALE, LLP, PO BOX 7068, PASADENA, CA, 91109-7068, US

(21) Appl. No.: 11/138,055

(22) Filed: May 26, 2005

Related U.S. Application Data
(63) Continuation-in-part of application No. 10/428,490, filed on May 2, 2003, now abandoned.
Application No. 10/428,490 is a continuation-in-part of application No. 09/752,975, filed on Dec. 27, 2000, now Pat. No. 6,784,591.
Application No. 09/752,975 is a continuation-in-part of application No. 09/616,683, filed on Jul. 14, 2000, now Pat. No. 6,417,597.
Application No. 09/616,683 is a continuation-in-part of application No. 09/443,527, filed on Nov. 19, 1999, now Pat. No. 6,160,336.

(51) Int. Cl. G01V 7/00

(52) U.S. Cl. 310/10; 310/300; 250/358.1

(57) ABSTRACT

A gravitational-wave generating device is positioned on one side of a material object and a gravitational-wave detection device is positioned on the other side of the material object. The intervening material object's texture and internal structure will modify the gravitational wave's polarization, backscatter, phase velocity (which results in gravitational-wave bending), phase, frequency, or other characteristics and serve to image the material object's texture and internal structure when the gravitational-wave detector on the other side of the material object is connected to a display device. The gravitational waves can also be generated by a celestial background source or sources. Multiple gravitational wave generators and/or detectors, which can be in motion, can be utilized in order to obtain stereoscopic, three-dimensional views of the material object's texture and internal structure and to eliminate or screen out unwanted features of the material object.

### CROSS-REFERENCE TO RELATED PATENTS AND APPLICATION(S)

This application is a continuation-in-part of U.S. application Ser. No. 10/428,490 filed May 2, 2003 which is a continuation-in-part of U.S. application Ser. No. 09/752,975 filed Dec. 27, 2000, now U.S. Pat. No. 6,784,591, issue date Aug. 31, 2004 which is a continuation-in-part of U.S. patent application Ser. No. 09/616,683, filed Jul. 14, 2000, now U.S. Pat. No. 6,417,597, issue date Jul. 9, 2002, which is a continuation-in-part of U.S. patent application Ser. No. 09/443,527, filed Nov. 19, 1999, now U.S. Pat. No. 6,160,336, issue date Dec. 12, 2000, the disclosures of which are incorporated herein by reference.

### FIELD OF THE INVENTION

The present invention utilizes a gravitational-wave source or sources on one side of a material object and a gravitational-wave detector or detectors on an opposite side together with a display device, which could be a computer screen, to image the material object's texture and/or internal structure.

### BACKGROUND OF THE INVENTION

This invention relates to the utilization of gravitational waves to image the texture and internal structure of a material object. Gravitational waves pass through most material with little or no attenuation; but their polarization, frequency, phase velocity (causing refraction or bending of gravitational rays), backscatter, phase, and/or other characteristics can be modified by a material object's texture and internal structure.

The general concept of the present invention is to image the texture and internal structure of a material object that is interposed between a source or sources of gravitational waves and a detector or detectors of gravitational waves. Thus the detectors can reveal the texture and internal structure of the material object in a similar, although substantially different, way than X-rays do in the electromagnetic wave spectrum. In the case of X-rays the electromagnetic (EM) radiation is far less penetrating than the gravitational radiation and ordinarily the absorption of the EM or X-ray waves precludes the imaging of the texture and internal structure of large intervening material objects, such as a building or the Earth itself, between the X-ray generator or source and the detector or film. Gravitational waves (GWs) can, in fact, propagate directly through the Earth and are not absorbed, but the change in polarization, backscatter, phase velocity (causing bending of the GW by the intervening material), etc., discloses the texture and internal structure of the intervening material between the GW generator or source and the GW detector or receiver. The source of the gravitational waves can be one or more of the gravitational-wave generators described in U.S. Pat. No. 6,417,597, issue date Jul. 9, 2002, which is a continuation-in-part of U.S. Pat. No. 6,160,336, issue date Dec. 12, 2000 and of U.S. Pat. No. 6,784,591 issue date Aug. 31, 2004 or it can be the primordial or relic cosmic background or other source or sources. The gravitational-wave detector or detectors can be those described in '597 and '975. Multiple gravitational-wave generators and/or detectors, which can be in motion relative to the material object, can be utilized to provide a stereoscopic or three-dimensional view of the material object's texture and internal structure and/or suppress or screen out unwanted features of the material object's texture or internal structure. A specific example of a gravitational-wave generator/detector system will be utilized to illustrate the practical application of the present invention. In this example the gravitational-wave generator or generators will be situated on one side of the Earth, at or near sea level, for example near Chongqing, China, whereas the detector or detectors can be spacebourne. Thus the detector(s) motion relative to the material object as, for example, being Earth-satellite based. About 200 km above sea level on the side of the Earth opposite the generator, for example, over South America.

Robert M. L. Baker, Jr. in U.S. Pat. No. 6,784,591 issue date 31 Aug. 31, 2004, which is a continuation-in-part of U.S. Pat. No. 6,417,597, issue date Jul. 9, 2002, which is a continuation-in-part of U.S. Pat. No. 6,160,336, issue date Dec. 12, 2000 describe various devices for the generation and detection of gravitational waves. One element of the present invention, specifically the gravitational-wave generator, is based upon the disclosure and claims 1, 4, 17, 23, and 33 of the '597 patent and the disclosure and claims 15, 68, and 94 through 100 of the '591 patent and will utilize two opposing laser targets as energizable elements and laser beams as energizing elements which are under computer control.

Also described in '591 patent is a lens system for use in focusing and/or concentrating gravitational waves. Such a system is useful, but neither critical nor essential for the operation of the invention and will not, in fact, be utilized in the illustrative example. Graviton-beam focusing as described in G. Veneziano, “Mutual focusing of graviton beams,” Modern Physics Letters A, Volume 2, Number 11, page 900 presents an alternative means for focusing and/or concentrating the gravitational waves. The primordial or relic cosmic gravitational wave background, which can be utilized as a natural source of gravitational wave illumination, is discussed by R. Brustein, M. Gasperini, M. Giovannini, and G. Veneziano (1995), “Relic gravitational waves from string cosmology”, Physics Letters B, Volume 361, pp. 45-51 and by Fangyu Li and R. M. L. Baker, Jr. (2005), “Perturbative Photon Fluxes Generated by High-Frequency Relic Gravitational Waves Utilized for their Detection,” Physics Letters B, in press. The fact that, for example, the phase velocity of the gravitational waves can be changed by the material through which it passes is discussed on page 5491 of Ning Li and Douglas G. Torr (1992), “Gravitational effects on the magnetic attenuation of super conductors”, Physical Review B, Volume 46, Number 9. Such a speed change will cause refraction or bending of the HFGW passing through the material object's texture and internal structure and will be sensed by the detector.

Another element of the present invention, a gravitational-wave detector or receiver, is based upon the disclosure and claims 73 and 74 of the '591 patent in which the gravitational-wave detector collection element could be a miniaturized coupled system of resonance chambers as described in Andrea Chincarini and Gianluca Gemme (2003), “Micro-wave based High-Frequency Gravitational Wave detector,” paper HFGW-03-103, Gravitational-Wave Conference, The MITRE Corporation, May 6-9, or it could be a miniaturized-microwave-waveguide loop as described in A. M. Cruise (2000), “An electromagnetic detector for very-high-frequency gravitational waves,” Class. Quantum Gravity, Volume 17, pp. 2525-2530, or it could be a coupling system of semi-transparent-beam-splitters and a narrow pulsed Gaussian beam passing through a static magnetic field. This last-mentioned detection device is selected to be utilized as the example and its orientation and frequency of its pulsed Gaussian beam will be under specialized computer control .in order to define the incoming HFGW's polarization, phase, frequency, etc. This detector is described in Li, Fang-Yu, Tang, Meng-Xi, Luo, Jun, & Li, Yi-Chuan (2000), “Electrodynamical response of a high-energy photon flux to a gravitational wave.” Physical Review D, Volume 62, July 21, 044018-1 to 044018-9, in Fang-Yu Li, Meng-Xi Tang, and Dong-Ping Shi, (2003), “Electromagnetic response of a Gaussian beam to high-frequency relic gravitational waves in quintessential inflationary models,” Physical Review B, Volume 67, pp. 104006-1 to -17. and, including a description of the gravitational-wave generator element, in Robert M. L. Baker, Jr. and Fang-Yu Li (2005), “High-frequency gravitational wave (HFGW) generation by means of a pair of opposed X-ray lasers and detection by means of coupling linearized GW to EM fields,” in the proceedings of Space Technology and Applications International Forum (STAIF-2005), edited by M. S. El-Genk, American Institute of Physics Conference Proceedings, Melville, N.Y., Volume 746, page 1271. These five references are incorporated herein by reference. The change in polarization of a GW passing through a material object is discussed in C. W. Misner, K. S. Thorne, and J. A. Wheeler (1973), Gravitation, W. H. Freeman and Company, New York, pp. 956-957, section 35.8. Specifically, “In the real universe there are spacetime curvatures due not only to the energy of gravitational waves, but also more importantly to the material content of the universe . . . its wavelength changes (gravitational red shift) and its (gravitational wave) backscatters off the curvature to some extent. If the wave is a pulse, the backscatter will cause its shape and polarization to keep changing . . . ”

### BRIEF DESCRIPTION OF THE DRAWINGS

FIG. 1 is a diagram of a gravitational wave source 1 on one side of a material object 2 generating gravitational waves 3 that are modified by the material object's texture and/or internal structure 4 and the gravitational waves are projected on to a detector or array of detectors 5 that are, in turn, connected 6 to a display device 7.

FIG. 2 is similar to FIG. 1 except that a gravitational wave lens 8 is interposed between the gravitational wave generator or source 1 and the material object 2.

FIG. 3 is similar to FIG. 2 except that a gravitational wave lens 9 is disposed between the material object 2 and the detector and/or detectors 5.

FIG. 4 is similar to FIG. 1 except that there are two or more gravitational wave generators 10, which can be in motion 11, disposed on one side of a material object 2.

FIG. 5 is similar to FIG. 1, except that there are two or more detectors or arrays of detectors 12, which can be in motion 13, and connected 14 via a display computer 15 to a display device 7.

FIG. 6 is similar to FIG. 1 except that the gravitational waves are generated by a celestial background source 16.

FIG. 7A is a diagram of a pair of rotating masses and their associated centrifugal-force vectors and the change in that force, Δf_{cf}, over time, Δt, or a jerk.

FIG. 7B is a diagram of the emulation of such rotating masses by two overall fixed masses acted upon by a force change, Δfₜ, over time, Δt, which is the same as the jerk shown in FIG. 7A. FIG. 7B also exhibits a blow up of the HFGW radiation pattern at the generator's focus occasioned by the jerks.

### DETAILED DESCRIPTION OF THE INVENTION

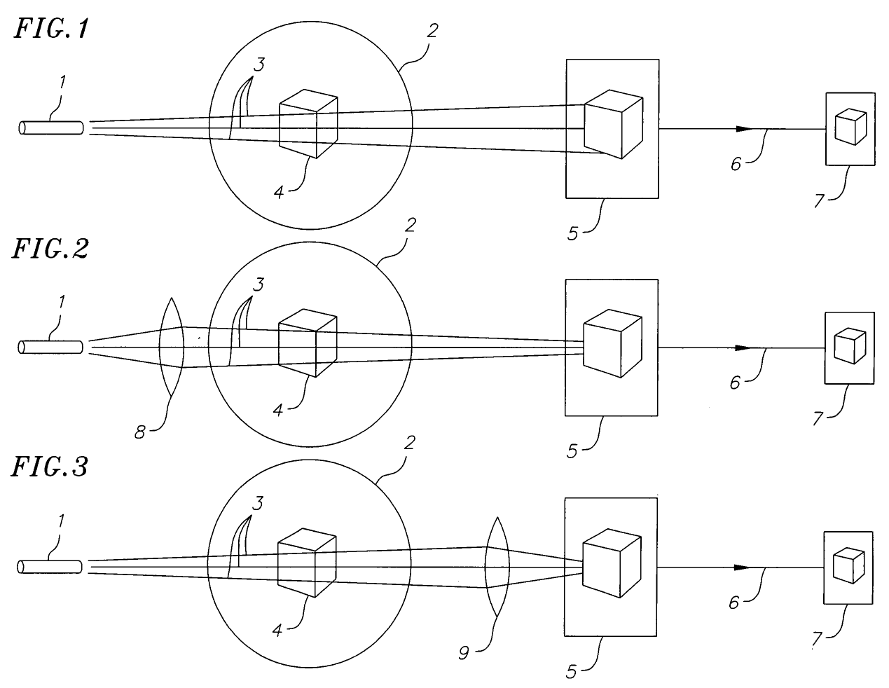

In FIG. 1 the gravitational wave source, such as a gravitational wave generator 1 on one side of a material object 2 generates gravitational waves 3 that are modified by a material object's texture or internal structure 4 and the gravitational waves are projected against a detectors or array of detectors 5 that are connected 6 to a display device 7, such as a computer screen, to present an image of the texture or internal structure of the material object created by the modified gravitational waves.

In FIG. 2 a gravitational wave lens 8 is interposed between the gravitational wave generator 1 and the material object 2 in order to accentuate the texture and/or internal structure 4 view of the material object on the display device 7.

In FIG. 3 a gravitational wave lens 9 is disposed between the material object 2 and the detector or array of detectors 5 in order to accentuate the texture and/or internal structure 4 of the material object on the display device 7.

In FIG. 4 there are two or more gravitational wave generators 10, which may be in motion 11 relative to the material object, in order to provide for a three-dimensional of the texture or internal structure of the material object.

In FIG. 5 there are two or more detectors or arrays of detectors 12, which may be in motion 13 relative to the material object and connected 14 via a display computer 15 to a display device 7, such as a computer screen, in order to provide for a three-dimensional view of the texture and/or internal structure of the material object.

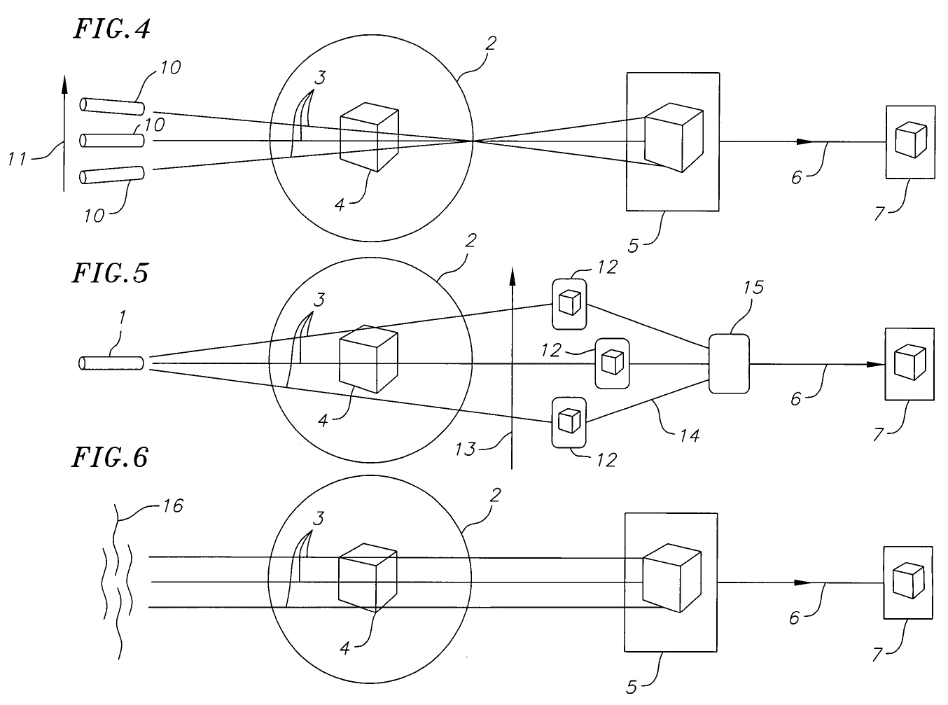

In FIG. 6 the gravitational waves are generated by a celestial source 16 such as the relic or primordial cosmic background.

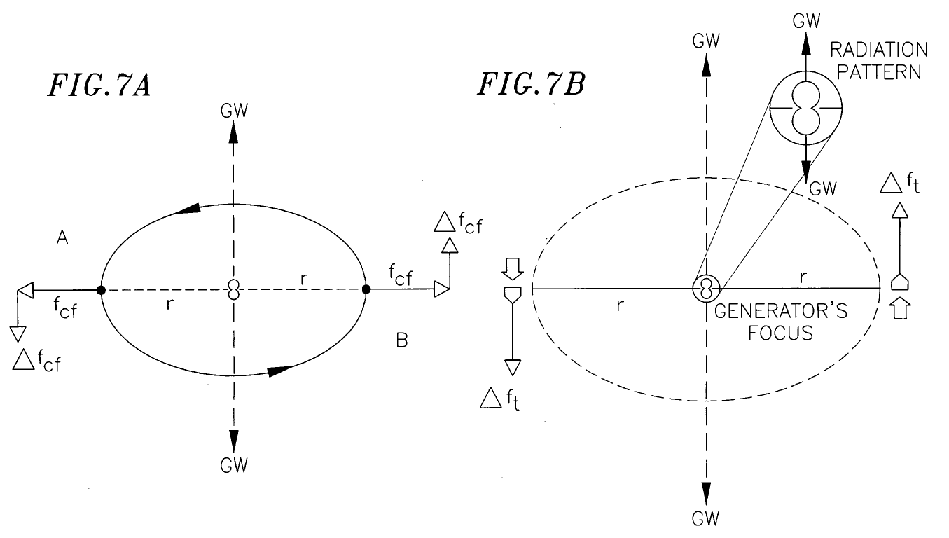

In FIG. 7A a pair of masses, rotating about one another, exhibit centrifugal-force jerks.

In FIG. 7B the centrifugal-force jerks are emulated by a pair of masses (e.g., laser targets) acted upon by lasers to emulate the centrifugal-force jerks and generate HFGWs having a radiation pattern at the generator's focus as shown in the figure.

### NUMERICAL EXAMPLE

One could, for example, utilize the existing 33.9 fs pulse-duration, table-top, ultra-intense, ultra-short, Shanghai-Institute-of-Optics-and-Fine-Mechanics' laser in China and the China-Academy-of-Engineering-Physics' Super-Strong lasers, (or similar tabletop lasers operated by the Lawrence Livermore National Laboratory, California, USA; the VNIFTRI, Mendeleevo, Moscow Region, Russia; the Colorado State University, Fort Collins, Colo., USA; the NTT Basic Research Laboratories, Kanagawa, Japan; the Department of Physics, University of New York, Hesklington, N.Y., USA; or the Max Planck Institute, Garching, Germany, etc.) assembled at a common site some 24 km apart. As a numerical example, with a 33.9 fs pulse duration, Δt, a ten-Hz repetition rate (ν_{GW}), a laser wavelength, λ_{EM}, of 800 nm (laser frequency of ν_{EM}=c/λ_{EM}=3.75×10¹⁴ Hz), a laser-photon energy of hc/λ_{EM}=2.48×10⁻¹⁹ J, and 2.3 PW of power, P, there would be PΔt/photon-energy=2.3×10¹⁵×3.39×10⁻¹⁴/2.48×10⁻¹⁹=3.14×10²⁰ photons-per-pulse or packet and the photons-per-second is 3.14×10²⁰/33.9 fs=9.27×10³³. Thus the impulsive force is the photons-per-second times the momentum of each photon or Δf=(1+R){(h/λ_{EM})}×(photons-per-second)=(1+0.95){(6.62×10⁻³⁴)/(800×10⁻⁹)}×9.27×10³³=1.5×10⁷N which is an extremely forceful strike on the target (factor of (1+R) since laser photons are reflected with reflectivity R at the mirrored target). The 33.9 fs ultra-short pulses are not monochromatic; they involve a wide range of wavelengths, frequencies, and energies (however, for a given repetition rate, and laser power, the Δf is independent of the wavelength of the electromagnetic laser). It is noted that we are dealing with four different frequencies: electromagnetic-laser, Gaussian-beam-laser, GW-pulse, and GW where ν_{EM}>ν_{GB}=ν_{GP}>>ν_{GW}. As Giorgio Fontana has pointed out (personal e-mail communication, Feb. 22, 2005), these intense ultra-short pulses of force, which occur every tenth of a second, produce very high-frequency GW (ν_{GP}) pulses or HFGW with, essentially, a fundamental 10 Hz (ν_{GW}) modulation or “carrier wave” in radio parlance. Fontana also notes that with a GW frequency of “. . . 10 Hz the wavelength is 30,000 km. At ranges shorter than that the near-field effect . . . dominate(s) and no (theoretical) proof of GWs can be given.” On the other hand, there is no reason not to expect GW's even if it is difficult theoretically to estimate them. In any event, using the jerk formulation of the quadrupole equation, which is certainly valid for GW-pulse lengths of cΔt=10 μm that is so short not to have a near-field effect, two hundred of these lasers oppositely directed and accurately positioned 24 km apart (12 km radius-of-gyration) generate a peak HFGW power of
P=1.76×10⁻⁵²(200 targets×2 r×Δf/Δt)2=790 W. (1)

The Gaussian beam of the detector has a 0.025 m radius, and, for example, is situated at a distance, D, from the focus of 1.296×10⁷. Such a distance represents the diameter of the Earth plus a 200 km height of a detector-bearing satellite. The HFGW do not radiate isotropically, but rather exhibit a radiation pattern analyzed on page 256 of Landau and Lifshitz (1972) op cit. The radiation pattern is FIG. 8 shaped or more expressly as a section of a dumbbell or peanut as shown in FIG. 7B. Specifically, the equation (10) from R. M. L. Baker, Jr., E. W. Davis, and R. Clive Woods (2005), “Gravitational Wave (GW) Radiation Pattern at the Focus of a High-Frequency GW (HFGW) Generator and Aerospace Applications,” in the proceedings of Space Technology and Applications International Forum (STAIF-2005), edited by M. S. El-Genk, American Institute of Physics Conference Proceedings, Melville, N.Y. 746, p. 1315., which is incorporated herein by reference, approximately holds and the HFGW flux equals (peak HFGW power) (2.54)(0.282/D)²=9.6×10⁻¹³ Wm⁻² peak HFGW flux at a detector that is 1.296×10⁷ m in front of (or behind) the focus. For the detector we have selected, described in Fang-Yu Li, Meng-Xi Tang, Dong-Ping Shi, Phys. Rev. D 67, 104008-1 (2003) and Fang-Yu Li, Nan Yang, Chinese Phys. Lett. 21, 11, 2113 (2004) and incorporated herein by reference, the detector averages this input flux over the pulsed-Gaussian-beam cross-section area. Here we choose at the detector a static magnetic field of B=15 T and the pulse-Gaussian beam of the focal-spot radius of 2.5 cm, so that by computer numerical integration, with electromagnetic power of 10¹⁶ W or 10 PW (over an exceedingly short period of time, say 33.9 fs, so that the laser targets will not be damaged), the amplitude of electrical field of the Gaussian beam will be ψ₀=1.78×10¹⁵ Vm⁻¹=1.780 PVm⁻¹. Please note that the generation of strong static magnetic field of 15 T in a 5 cm gap of the selected detector is well within the current technology.

The amplitude of the HFGW with emulated “angular-frequency,” ω, is
A=(8 πG F_{GW}/c³ω³)^{1/2}=1.28×10⁻¹⁸ F_{GW}^{1/2}/ν. (2)

Equation (2) is strictly valid for monochromatic or quasi-monochromatic GW; but the GWs may cover a wide range of frequencies, the fundamental one being the pulse repetition rate or PRR or, analogously to the orbital-motion shown in FIG. 7 A, twice the orbital frequency. Of course, we are only looking at a very brief snapshot of the emulated orbit or a very short segment of a relatively long GW. At the detector at a 200 km altitude and fundamental GW frequency, ν_{GW}=10 Hz we have predicted a GW amplitude of A=1.25×10⁻²⁵ and there 4×10²¹ gravitons (at the pulse frequency, ν_{GP}=29.5 THz). By computer-numerical-integration, given an electromagnetic power of 10¹⁴ W, the amplitude of electrical field of the Gaussian-detection-laser beam will be ψ₀=1.8×10¹⁵ Vm⁻¹. Using such values and the approximate form for the perturbative-photon-flux (PPF) produced by the GWs or PPF-density propagating along the x-axis we obtain for the total perturbative-power-flux detection-signal, u, passing through the effective receiving surface (the surface area is approximately the area of the Gaussian beam's cross-section, δs)
u˜ABψ₀δs=5.3×10⁻⁸ W, (3)
where μₒ=4 n×10⁻⁷, the static-magnetic field and B=15 T. Of course, such process occurs in a very short-detection duration δt=10,000 Δt=3.39×10⁻¹⁰ s (the duration of the detection-observation is 10,000 times the period of GW, i.e., integrated over 10,000 GW pulses) thus the total output energy in the duration δt will be ΔEᵣ=uδt=1.8×10⁻¹⁷ J. This corresponds to the energy of ΔEᵣ/hν_{GB}=1.8×10⁻¹⁷/1.95×10⁻²⁰=916 detection photons (or 100 to 10,000 times that number for the more powerful advanced version of the SIOM laser) which is more than sufficient for detection with little or no noise at this frequency and allows for sufficient “bandwidth” for the analysis of the HFGWs signal's polarization, phase, etc. For example, polarization of the GWs can be ascertained by rotating the detector's magnetic field and observing the change number of detection photons. Backscatter (which reduces the GW amplitude) and phase velocity (which results in bending or refracting the GWs) can be sensed by measuring the number of detection photons in different detector locations relative to the line of sight to the GW generator. Phase and frequency of the GWs can be measured by changing the phase and frequency of the detector's Gaussian beam and measuring the change in detection-photon flux. Other detectors, such as the miniaturized-microwave-waveguide loop and the miniaturized coupled system of resonance chambers can utilize similar techniques of detector orientation, location, and tuning to establish GW polarization, backscatter, phase velocity, phase and frequency. In Eq. (3) ABψₒ/μₒ, is the first-order-perturbative-EM-power-flux density or Poynting vector. The above results show that although ΔE, is a very small value, the PPF in terms of integrated photon count in the duration will be an observable value.

1. An apparatus for imaging the internal structure of a material object comprising:
an emission source of gravitational waves positioned on one side of the object; and
a gravitational wave detector positioned on the opposite side for detecting modification of a characteristic of the gravitational waves passing through the object.

2. An apparatus according to claim 1 wherein the source of the gravitational waves is a gravitational wave generator.

3. An apparatus according to claim 2 wherein gravitational wave generator has directionality to its gravitational wave emission.

4. An apparatus according to claim 2 wherein the gravitational wave generator exhibits a single constant polarization of its gravitational wave emission.

5. An apparatus according to claim 1 wherein at least one gravitational wave lens is interposed between the gravitational wave source and the material object.

6. An apparatus according to claim 1 wherein at least one gravitational wave lens is interposed between the material object and the gravitational wave detector.

7. An apparatus according to claim 1 wherein the source of the gravitational waves is two or more gravitational wave generators.

8. An apparatus according to claim 1 wherein the gravitational wave generator is movable.

9. An apparatus according to claim 1 two or more gravitational wave detectors are provided.

10. An apparatus according to claim 1 wherein the gravitational wave detector is movable.

11. An apparatus according to claim 1 wherein the characteristic is polarization.

12. An apparatus according to claim 1 wherein the characteristic is backscatter.

13. An apparatus according to claim 1 wherein the characteristic is phase velocity.

14. An apparatus according to claim 1 wherein the characteristic is phase

15. An apparatus according to claim 1 wherein the characteristic is frequency.

16. An apparatus according to claim 1 wherein the emission source is a celestial source.
